(19) United States
(12) Patent Application Publication
(10) Pub. No.: US 2002/0028860 A1
(43) Pub. Date: Mar. 7, 2002

(54) METHOD OF MODIFYING RHEOLOGY OF SLURRIES IN MINERAL PROCESSING

(76) Inventors: E. MICHAEL KERR, AURORA (XP); SANA KHAN, SOUTH BELMORE (AU); CATHY C. JOHNSON, GENEVA, IL (US); WAYNE M. CARLSON, BATAVIA, IL (US)

Correspondence Address: KELLY L CUMMINGS, NALCO CHEMICAL COMPANY, PATENT & LICENSING DEPARTMENT, ONE NALCO CENTER, NAPERVILLE, IL, 605631198

(21) Appl. No.: 09/293,163

(22) Filed: Apr. 16, 1999

(51) Int. Cl. C08K 3/20

(52) U.S. Cl. 524/60; 524/413; 524/435; 524/443; 524/493

(57) ABSTRACT

A method is provided for modifying the rheology of a slurry of a mineral-containing solid material and water by adding a low molecular weight sulfonate-containing polymer to the slurry. The polymer preferably comprises acrylamide, acrylic acid and acrylamidomethyl sulfonate. The inventive method has applications in the nickel ore, cobalt ore, precious metals ore, copper ore, taconite, mineral sands, coal and bauxite industries.

### FIELD OF THE INVENTION

The present invention relates to the handling of slurries of mineral-containing solid material and water in mining and mineral processing applications. More specifically, the present invention relates to additives used for rheology modification of slurries of mineral-containing solid material and water in mining and mineral processing applications.

### BACKGROUND OF THE INVENTION

Mining and mineral processing and refining generally involves the combining of the mined material and water to form a slurry. For example, the ore is mined and combined with water to form a slurry so that the ore may be upgraded by washing the ore with water to remove undesirable gangue material which may consist of fine clay, soil or other contaminants.

Further, the mined material must also be ground or milled to a smaller particle size. Typically, a wet grinding process is used where the mined material is combined with water to form a slurry before the slurry is fed to a mill. In recent years, wet grinding processes have replaced dry grinding processes because wet grinding reduces energy costs, permits a reduction in size of the grinding mill because of its lower energy consumption and further because wet grinding provides improved pollution control due to the reduction of airborne rock dust and other particulates.

However, disadvantages associated with wet grinding include difficulties in controlling the feeding of oversized rock to the grinding mill, excessive consumption of water and potential overgrinding of softer, more porous rock. All of these problems can be reduced or alleviated by modifying and/or reducing the viscosity of the slurry because a reduced or more constant viscosity promotes better grinding by reducing the proportion of oversized particles, a better flow of slurry through the mill, and the more efficient operation of cyclones used in closed-loop processes. Reduced viscosity also allows a higher percentage of solids in the slurry to be used, thereby resulting in less water consumption and reduced water evaporation processes downstream. Further, a reduction in viscosity also results in a higher residence time in the mill without sacrificing percent solids and particle size distribution. Improving the consistency of the slurry viscosity increases the consistency of the particles obtained during the milling process. In short, viscosity modification of the slurry results in higher throughput and lower energy consumption.

Because the creation of a slurry is so prevalent in mining and mineral processing, reducing the viscosity of slurries has other applications as well. For example, many downstream treatments of the ore result in the creation of a slurry and the transport thereof. Accordingly, a reduction in slurry viscosity reduces pumping costs. While the reduction in pumping costs is important within a processing plant, the reduction in pumping costs is also important in locations where the ore is transported from the mine to the processing plant by creating a slurry and pumping the slurry from the mine to the processing plant. Often, the distance between the mine and the plant can exceed 50 kilometers and include substantial rises in elevation.

Therefore, rheology modification in the form of viscosity reduction and improved slurry consistency is important in the mining and mineral processing industries and a number of rheology modifiers are available. For example, frequently employed rheology modifiers include the homopolymer of acrylic acid which may have a molecular weight ranging from 5,000 to 300,000 amu. The term “acrylic acid” is generally known by those skilled in the art and is used herein to include acrylic acid and its various salts, such as sodium, potassium, ammonium, calcium and other like acrylates. The typically used polymers may be found as neat polymer products or as products of diluted polymer in water solutions.

While the above-listed rheology modifiers have proven useful in reducing viscosity, there was always a need for improved rheology modifiers that provide enhanced viscosity reduction or equivalent viscosity reduction at lower dosage rates and/or lower costs.

### SUMMARY OF THE INVENTION

The present invention satisfies the aforenoted need by providing a method for modifying the rheology of the slurry of a mineral-containing solid material and water that includes the step of adding to the slurry a low molecular weight sulfonate-containing polymer. As used herein “adding to the slurry” means either during the preparation of the slurry or during its subsequent manipulation, e.g., pumping of the slurry for transparation or for processing the slurry to extract the mineral value.

In an embodiment, the mineral-containing solid material includes nickel ore, cobalt ore, precious metals ore, copper ore, taconite, mineral sands, coal, bauxite and mixtures thereof.

In an embodiment, the polymer is a sulfonate-containing polyacrylamide, a sulfonate- containing polyacrylic acid or a mixture thereof. As used herein, a “sulfonate-containing polyacrylamide” is meant to include the sulfonated homopolymers of acrylamide or their homologs and the sulfonated copolymers, including terpolymers, of acrylamide or their homologs with acrylic acid or its homologs. A “sulfonate-containing polyacrylic acid” as used herein is meant to include the sulfonated homopolymers of acrylic acid or their homologs.

In an embodiment, the polymer comprises acrylamide or substituted acrylamide, acrylic acid or substituted acrylic acid, and a sulfonate functional group.

In an embodiment, the polymer comprises acrylamide, acrylic acid and acrylamidomethyl sulfonate.

In an embodiment, the polymer has a molecular weight ranging from about 2,000 to about 20,000 amu.

In an embodiment, the polymer is further characterized as comprising from about 3 to about 40 mole % acrylamidomethyl sulfonate, from about 5 to about 45 mole % acrylamide and from about 30 to about 70 mole % acrylic acid.

In an embodiment, the polymer is further characterized as comprising from about 5 to about 10 mole % acrylamidomethyl sulfonate, from about 30 to about 40 mole % acrylamide and from about 55 to about 65 mole % acrylic acid.

In an embodiment, the present invention provides a method for modifying the rheology of a slurry of a mineral-containing solid and water which comprises the step of adding to the slurry, either before, during or after the preparation of the slurry or during its subsequent manipulation, e.g., pumping of the slurry for transparation or for processing the slurry to extract the mineral value, a low molecular weight sulfonate-containing polymer.

It is therefore an advantage of the present invention to provide an improved rheology modifier for mining and mineral processing applications.

Another advantage of the present invention is that it provides improved methods of modifying the rheology of slurries of water and mineral-containing solid materials.

Yet another advantage of the present invention is to provide a rheology modifier that reduces viscosity at lower dosage rates than currently-available rheology modifiers.

Yet another advantage of the present invention is to provide a new use for sulfomethylated acrylamide:acrylic acid polymers.

Other objects and advantages of the invention will become apparent upon reading the following detailed description and appended claims.

### DETAILED DESCRIPTION OF THE PRESENTLY PREFERRED EMBODIMENTS

The present invention provides a method of rheology modification of a slurry of water in a mineral-containing solid material by adding a polymer to the slurry either before, during or after the preparation of the slurry.

The polymer is a low molecular weight sulfonate-containing polymer, preferably, a polymer comprising acrylamide, acrylic acid and acrylamidomethyl sulfonate. It is understood that the term “sulfonate” includes sulfonic acid and its various salts such as sodium, potassium, ammonium, calcium sulfonate, and the like. Such sulfonated polymers are well known and may be prepared via a number of known methods including polymerization of vinyl monomers containing the sulfonate functional group (i.e. vinyl sulfonate, sulfonated styrene, and AMPS (2-acrylamido-2-methy propane sulfonic acid)). Preparation of a broader variety of sulfonate-containing polymers are available via transamidation of polymers containing pendant amide functional groups such as those taught in U.S. Pat. No. 4,703,092. Polymers of acrylic acid or methacrylic acid can also be sulfonated for use in this invention using known methods such as those taught in U.S. Pat. No. 4,795,789. These sulfonate-containing polymers might also contain other functional groups which could enhance the use of these sulfonated polymers in this invention.

More specifically, the polymer can comprise a backbone of acrylamide and acrylic acid and which has been sulfomethylated so that the polymer further includes acrylamidomethyl sulfonate. The acrylamidomethyl sulfonate content can range from about 3 to about 40 mole %, more preferably from about 5 to about 10 mole %. The acrylamide content can range from about 5 to about 45 mole %, more preferably from about 30 to about 40 mole % and the acrylic acid from about 30 to 70 mole %, and more preferably from 55 to 65 mole %. The preferred commercially-available form of the polymer is sold under the trademark PRISM LL by the Nalco Chemical Company of Naperville, Ill.

The polymer may be added to any slurry of a mineral processing application or to the initial formation of a slurry of the mined material. For example, the polymer may be added to a wet grinding process but may be added to all subsequent downstream treatments of a slurry as well. As noted above, use of the polymer to modify rheology and reduce viscosity will prove useful when the mined material is transported in the form of a slurry by pumping.

Performance of the polymer utilized in the method of the present invention has been compared to the performance of other currently-available rheology modifiers and has been proven to be superior. For example, in Table I, one polymer utilized in the method of the present invention (Polymer C) was compared with a homopolymer of polyacrylic acid, ammonium salt (Polymer A) as well as the homopolymer poly(acrylic acid) (Polymer B). The molecular weight of Polymer A ranges from 5,000 to 100,000 amu and the molecular weight of Polymer B ranges from 10,000 to 300,000 amu. The dosage rates range from 30 grams per ton to 200 grams of polymer actives (tested on equal polymer actives) per ton of slurry solids. The yield stress was measured in dynes per centimeter squared (dynes/cm²) using Brookfield Engineering Laboratories, Rheocalc V1.1 Viscometer with computer assisted data accumulation and analyses. A LZ3 Spindle was used with a rotational ramp program of: “Speed Increment” of 20 RPM, “Speed Ramp Intervals” of 20 seconds, “Set Speed” of 10 RPM and “Wait For Speed” of 250 RPM. The temperature was maintained at 80° F. The material evaluated in Table I is a laterite nickel ore slurry from Western Australia. The test slurry was composed of saprolite and limonite laterites with overburden and had 43% solids. The lower the measured yield stress, the more effective the polymer is at reducing slurry viscosity.

TABLE I

| Dose (g/t) | A (dynes/cm²) | B (dynes/cm²) | C (dynes/cm²) |
|---|---|---|---|
| 0 | 330 | 330 | 330 |
| 30 | | | 310 |
| 50 | | 390 | |
| 70 | | | 250 |
| 100 | 360 | 375 | 230 |
| 200 | 260 | 255 | 210 |

Similarly, in Table II, one polymer used in accordance with the present invention (Polymer C) was compared with both Polymers A and B as described above as well as a 50:50 mix of water and the polyacrylic acid homopolymer of Polymer B (labeled as Polymer D). The material evaluated in Table II was a calcrete laterite ore slurry used for neutralization reactions in the laterite nickel process. The ore slurry had solids of 56%. Again, Polymer C proved to be superior in reducing yield stress (dynes/cm²).

Further, it will be noted from Tables I and II that Polymer C, at a dosage rate of 40% to 50% of the dosages for Polymers A, B and D still is proven to be more effective at reducing yield stress. Thus, use of Polymer C in lower dosage rates still provides more effective viscosity reduction than higher dosage rates for Polymers A, B and D.

The rheology modifying polymer may be added to the slurry or to water used to form a slurry in ball mill, cyclones, thickener underflow and feed thickener applications as well as bulk mixing applications. Use of the rheology modifying polymer clearly has applications in nickel, cobalt, precious metals, copper, taconite, mineral sands, coal, bauxite ores and mixtures thereof and mineral processing applications.

TABLE II

| Dose | | | | |
|---|---|---|---|---|
| (g/t) | A (dynes/cm²) | B (dynes/cm²) | C (dynes/cm²) | D (dynes/cm²) |
| 0 | 234 | 234 | 234 | 234 |
| 150 | | | 166 | |
| 200 | | | 141 | |
| 250 | | | 122 | |
| 300 | | 165 | 106 | |
| 400 | 191 | 148 | | |
| 500 | | 133 | | |
| 600 | | 126 | | |
| 700 | 147 | 113 | | |
| 800 | | | | |
| 900 | | | | 161 |
| 1000 | | | | |
| 1100 | | | | 140 |
| 1200 | | | | |
| 1300 | | | | 106 |

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

What is claimed is:

1. A method for modifying the rheology of a slurry of a mineral-containing solid material and water, wherein the mineral-containing solid material is nickel ore, cobalt ore, precious metals ore, copper ore, taconite, mineral sands, coal, bauxite or a mixture thereof, the method comprising adding to the slurry a low molecular weight sulfonate-containing polymer.

2. The method of claim 1 wherein the polymer is selected from the group consisting of a sulfonate-containing polyacrylamide, a sulfonate-containing polyacrylic acid or a mixture thereof.

3. The method of claim 1 wherein the polymer comprises acrylamide or substituted acrylamide, acrylic acid or substituted acrylic acid, and a sulfonate functional group.

4. The method of claim 1 wherein the polymer comprises acrylamide, acrylic acid and acrylamidomethyl sulfonate.

5. The method of claim 1 wherein the polymer is further characterized as having a molecular weight ranging from about 2,000 to about 20,000.

6. The method of claim 1 wherein the polymer is further characterized as comprising from about 3 to about 40 mole % acrylamidomethyl sulfonate, from about 5 to about 45 mole % acrylamide and from about 30 to about 70 mole % acrylic acid.

7. The method of claim 1 wherein the polymer is further characterized as comprising from about 5 to about 10 mole % acrylamidomethyl sulfonate, from about 30 to about 40 mole % acrylamide and from about 55 to about 65 mole % acrylic acid.
